(19) United States
(12) Patent Application Publication
(10) Pub. No.: US 2003/0231328 A1
(43) Pub. Date: Dec. 18, 2003

(54) Multiple printer driver

(75) Inventors: David M. Chapin, Gresham, OR (US); Jonathan A. Edmonds, Silverton, OR (US)

Correspondence Address: Patent Documentation Center, Xerox Corporation, Xerox Square 20th Floor, 100 Clinton Ave. S., Rochester, NY, 14644, US

(73) Assignee: Xerox Corporation

(21) Appl. No.: 10/165,521

(22) Filed: Jun. 7, 2002

(51) Int. Cl. G06F 3/12; G06F 15/00; G06F 13/00; G06F 11/30

(52) U.S. Cl. 358/1.13; 358/1.15; 710/19

(57) ABSTRACT

A single printer driver controls operation of a plurality printers on a network. The driver includes a user interface, a controller/logic analyzer and a communications port. The user interface displays a composite of printer features of the plurality of printers in a host device on the network, receives a user request for a print job and user-selected properties from the composite of printer features for the print job. The controller/logic analyzer, responsive to the request for a print job, the user-selected print job properties and the printer features of the plurality of printers, selects which printer is to be used for the print job according to predetermined criteria. The communications port routes the print job and selected print job properties to the selected printer.

### CROSS-REFERENCE TO RELATED APPLICATIONS

This application is related to applicants' co-pending, co-assigned U.S. applications entitled Method of Print-Time Printer Selection (Docket No. D/A2201) and Mobile USB Printer Driver (Docket No. D/A2202), which are filed concurrently with this application, the contents of which are incorporate herein by reference.

### FIELD OF THE INVENTION

This invention relates generally to network printers and more particularly to a printer driver which supports multiple printers on a network.

### BACKGROUND OF THE INVENTION

Printing on a network offers users the opportunity to print select from multiple printers with different functionality. In addition to being able to print to both color and monochrome printers, users on a network can select printers with more printing and post-print options (collation, binding, etc.). To enjoy the benefits of the various printers on a user's network, the user must install a separate driver onto their work station or personal computer for each printer the user wishes to access in their work area.

A printer driver is a software program which provides control of a printer, and which enables the user's work station or personal computer to communicate with the printer. A printer driver interfaces with both the operating system and the various applications (e.g., word processing, database management, spread sheet, etc.) that offer the print functionality. The printer driver provides a user interface which enables users to select physical functions such as paper size, orientation, paper source, number of copies, etc. and graphical functions such as color, monochrome, halftone, etc. Whenever a user prints a document, the software application sends the data to be printed to the printer driver. The driver translates the data into a format that the printer can understand and checks to see that the printer is online and available to print. The data is then sent by the driver from the computer to the printer via the connection interface (e.g., parallel, USB, etc.).

Although a network may permit a user to access all printers on the network, typically most users will only wish to print to printers in the user's work area (or within walking distance). For example, if a work area has one color printer and two monochrome printers, each user within the work area must install, maintain and learn to use a total of three printers on their personal computer. Before a user prints a document, the user must use his or her own knowledge of each printer's capabilities and current status to determine the printer best equipped to print the document.

Various technologies exist for enabling production jobs to be sent to multiple printers for completion. For example, U.S. Pat. No. 5,995,721 for Distributed Printing System, describes a system in which a single print job may be sent to multiple printers for completion. U.S. Pat. No. 6,333,795 for Method for Customizing Print Attribute Choices Based on Selected Model, Media, and Printer, describes a user interface for creating a job ticket in a network printing system and a method for updating the user interface to include print options available in the network printing system. U.S. Pat. No. 6,173,295 for Method, System, and Program for Creating a Job Ticket Including Information on Components and Print Attributes of a Print Job describes a method for creating a job ticket using a graphical user interface.

### SUMMARY OF THE INVENTION

A multiple printer driver, according to the invention, allows users to install, maintain and use a single printer driver to print to many networked office printers. The multiple printer driver determines for the user which printer within the user's work group is best equipped to print each print job. The multiple printer driver then sets the correct printer settings and automatically sends the document to the chosen printer for the user. The multiple printer driver can be used for any image forming device, such as printers, copiers, facsimile machines and multi-function machines in which a user can send a “print job” to be “printed”.

A driver for controlling operation of a plurality printers on a network, wherein each printer includes a plurality of printer features, includes a user interface for displaying a composite of printer features of the plurality of printers in a host device on the network, for receiving a user request for a print job and for receiving user-selected properties from the composite of printer features for the print job; a controller/logic analyzer, responsive to the request for a print job, the user-selected print job properties and the image forming features of the plurality of printers, for selecting, according to predetermined criteria, which printer is to be used for the print job; and a communications port for routing the print job and selected print job properties to the selected printer. The driver may also include an output generator for converting the print job and user-selected print job properties into a printer data format, such as PostScript or PCL (printer control language) for the selected printer.

### BRIEF DESCRIPTION OF THE DRAWINGS

FIG. 1 is a block diagram showing multiple printer driver installed on a user PC that controls three network printers;

FIG. 2 is a block diagram of multiple print driver;

FIGS. 3 and 4 are a flow chart illustrating differences between a desktop system with standard printer drivers and a desktop system with a multiple printer driver; and

FIG. 5 illustrates operation of a multiple printer driver.

### DETAILED DESCRIPTION OF THE EMBODIMENTS

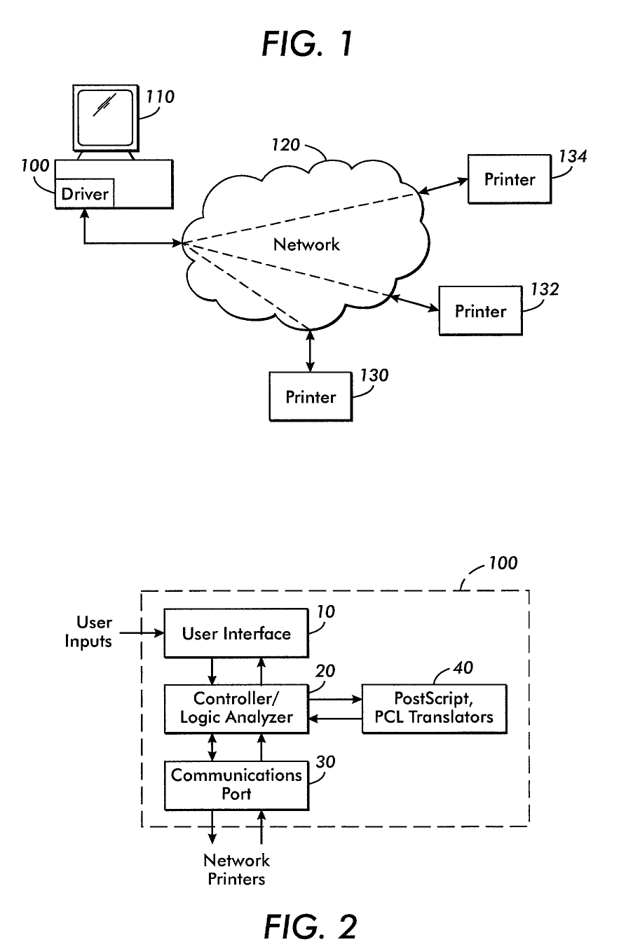

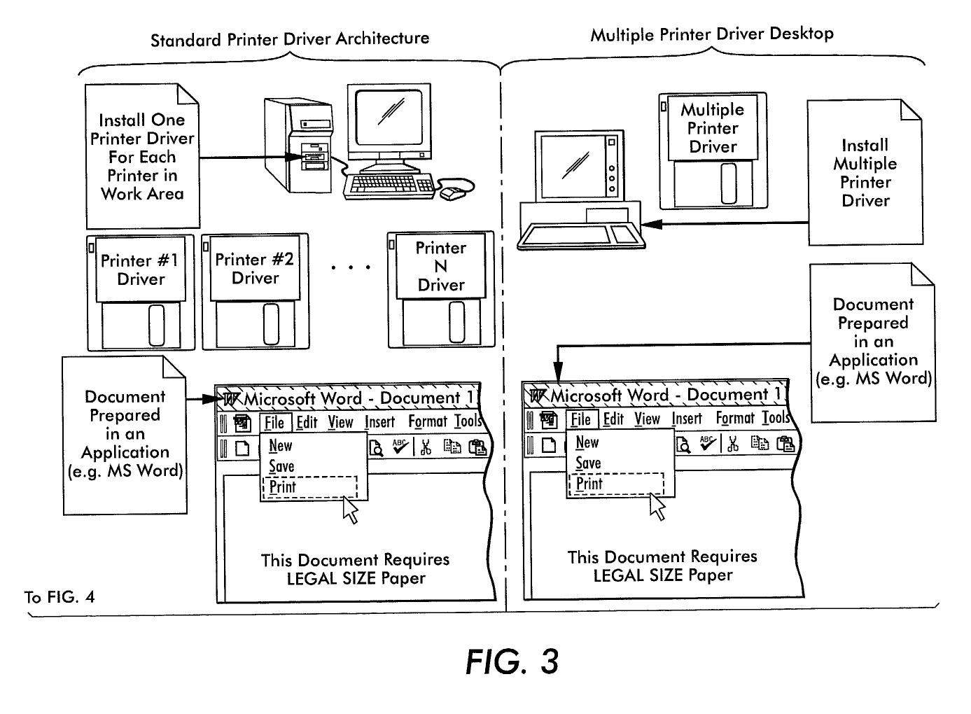

Referring to FIGS. 1 and 2, multiple printer driver 100 includes user interface 10, controller/logic analyzer 20 and communications port 30. Driver 100 installs onto a host device, which may be a work station or personal computer (PC) 110 connected to network 120, in the same manner as a standard printer driver would be installed. Driver 100 operates in much the same space as standard printer drivers and is evoked by software applications using the same methods as standard printer drivers. However, unlike standard printer drivers, driver 100 has the capacity to print documents to multiple physical printers 130, 132, 134 connected on the network 120. During installation of the driver the user will select to which of the available printers on the network the user wants to be able to send print jobs. Generally the printers 130, 132 and 134 will be located within a user's work area, office or building, but may be located elsewhere (for example, a user may wish to print occasionally to a high function printer located on another floor or building).

When a user selects a print function in the PC 110's operating system or an application program (such as a word processing program) running on PC 110, driver 100 displays user interface 10 on the monitor of the PC 110. User interface 10 is typically in the form of a pop-up window with inputs for the user to select the various print properties of the print job. The user interface 10 may be integrated with the operating system or application program with the print functionality. The user interface 10 displays a composite of the various print properties of each of the printers 130, 132 and 134, which gives the user the impression of printing to a single printer. The user selects the various print properties for the particular print job, such as number of copies, paper orientation, paper size, etc. and then selects to print the print job.

Controller/logic analyzer 20 takes the user's input from the user interface and determines which of the three printers 130, 132 and 134 is the best-equipped printer to complete the user's print job. The logic analyzer uses predetermined criteria to select the best-equipped printer. Some examples of criteria used by the logic analyzer to make printer determinations include: User Preference of Printers to use, Number of Pages to Print On each sheet of paper, Media Size, Media Type, Two Sided Printing, Black and White Document, Color Document, Output Features (Staple, hole punch, offset jogging, sorting), Print immediately, Print Quality, and Print Cost. Additional criteria may include the number of jobs already in the printer's queue and other dynamic variables. The logic analyzer is built on an extensible framework so that criteria can be added, modified and deleted as needed.

Once the controller/logic analyzer 20 has determined the best printer for the user's print job, the controller/logic analyzer 20 sends the print job and user-specified print properties to the communications port 30. Communications port 30 routes the print job and user-selected print properties to the selected printer. Communications port 30 may include a port monitor and a spooler. The port monitor monitors the status of the printers and sends the print job to the spooler. The spooler delivers the print job to the selected printer. Communications port 30 may communicate with the selected printer using an XML-based communication system, which would allow the printer to communicate its features and current status and to receive information on how to print the job. For example, the logic analyzer 20 may query the printer's firmware and obtain the URL of an XML document containing the printer's status and functions available. The logic analyzer 20 will then download the XML document, parse the XML into its constituent fields indicating functionality and status of the functionalities.

For printers which require the print job and user-specified print properties to be translated into a particular format, such as PostScript, PCL or some other specific format, a translator 40 is provided. Translator 40 contains the drivers and programs to translate the print job into the printer specified format. After translation, the controller 20 sends the translated print job to the communications port 30 which sends the translated print job to the selected printer.

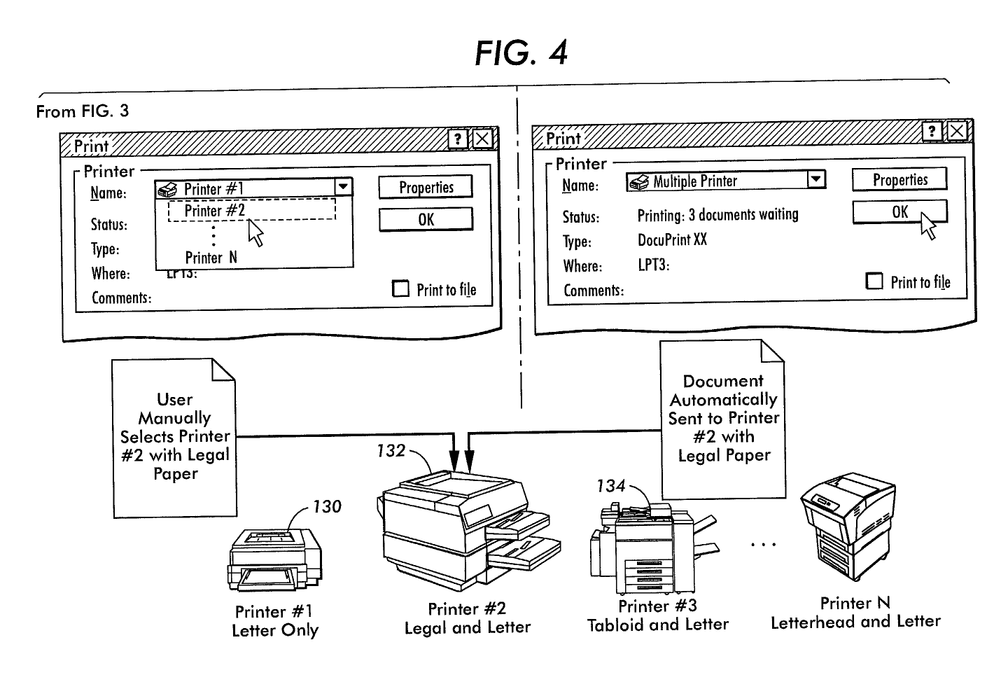

A flow chart illustrating differences between a desktop system with standard printer drivers and a desktop system with a multiple printer driver is shown in FIGS. 3 and 4 (FIG. 4 is a continuation of FIG. 3). The left side of FIGS. 3 and 4 illustrates a system and work flow in that system that uses a conventional printer driver architecture found on most personal computers. A user must install a separate printer driver for each printer within the work area. A separate driver is needed because each printer has different requirements for receiving and printing jobs. When a driver is installed on the user's personal computer, the driver may provide a separate user interface (which may be in the form of a dialog box). The print driver also integrates with any applications having a print functionality, so that the print functions are integrated into the particular application's user interface (e.g., a dialog box). In this example, the user is working on a document in an application such as Microsoft Word. The user selects the print function from the Word drop down menus. This particular document has been set up by the user to be on legal size paper. The Word application print dialog box requires the user to select from Printer #1, #2 or #3. In this case only printer #2 has legal size paper available for printing and the user must know this fact and manually select printer #2. After the user completes any other selections, such as number of copies, the user selects “OK” and the document is sent to printer #2.

The right side of FIGS. 3 and 4 illustrates a system in an environment where multiple network color and/or monochrome printers are available. The user installs a multiple printer driver on the PC. This multiple printer driver is configured to operate several different printers, each having different print functionality. It should be noted that if all the printers on a network are the same model and type, for example the Xerox Phaser 6200 printer, then installing a print driver for the Xerox Phaser 6200 printer alone is sufficient for operating all of the Phaser 6200 printers on the network. However, if there are Xerox Phaser 4400 printers and Phaser 7300 printers, for example, on the network, installing a multiple printer driver will enable the user to print to all Phaser 6200, 4400 and 7300 printers on the network.

The user installs and configures the multiple printer driver on the user's PC as the default printer. Once the driver is installed, the user would then select from all those printers on the network which are supported by the multiple printer driver and which have been selected by the user for it to access. The multiple printer driver analyzes the feature set of each selected printer and generates a composite list of features to be displayed in the user interface to the user. If all supported devices are selected (or if the multiple printer driver's default configuration selects all supported devices), the controller/logic analyzer in the multiple printer driver analyzes the feature set, finisher feature set, per page cost, pages per minute and current status of all the printers, copiers and fax machines on the user's network (and optionally, all coordinated vendor printers available on supported web sites if the network is connected to the Internet).

Referring again to the right side of FIGS. 3 and 4, the user is working on a document in a PC application such as Microsoft Word. The user is ready to print the document and selects <file> <print> from the application's menu. The standard application print dialog box opens showing the multiple printer as the default printer (here the multiple printer driver user interface has been integrated into the Word dialog box for the print function). The user clicks the <properties> button and the multiple printer driver user interface is displayed. The user selects the printer features required for the document. In this example, the user selected legal sized paper. The multiple printer driver analyzes the features selected by the user and the document properties (and any other predetermined criteria) and then automatically determines the printer within the work area best equipped to print the document. The multiple printer driver then displays the name/location of the printer best equipped to print the document. If this prompt is acceptable, the user clicks the <print> button. The multiple printer driver then routes the document to the printer that is best equipped to print the document. The user is able to view the “printing status” (page 2 of 10) of each document on the desktop. When the document is finished printing, the user is shown again where to pick up the printed document.

The multiple printer driver can be configured to provide the user with the option of seeing which printer the print job will be sent to before the user clicks the <print> or <OK> button in the user interface dialog box. The multiple printer driver may be configured so that the user is only notified when the job is completed and where to pick up the print job. The specific printing solution a document is actually sent to and printed on remains chiefly transparent to users during the feature selection and printer settings process.

The multiple printer driver can be configured to monitor current status of the printers it controls. The multiple printer driver may include a query module for checking at some predetermined time, for example, when the user opens the multiple printer driver dialog box, the status of the printers. Status checking may include checking to see if the printer is currently printing a job, if the printer is active on the network, and for those printers enabled with consumables status information, for checking status of selected consummables (e.g., how much paper is in a particular tray or container). The multiple printer driver can generate the set of composite features when first installed, when launched during a print operation or manually by user selection.

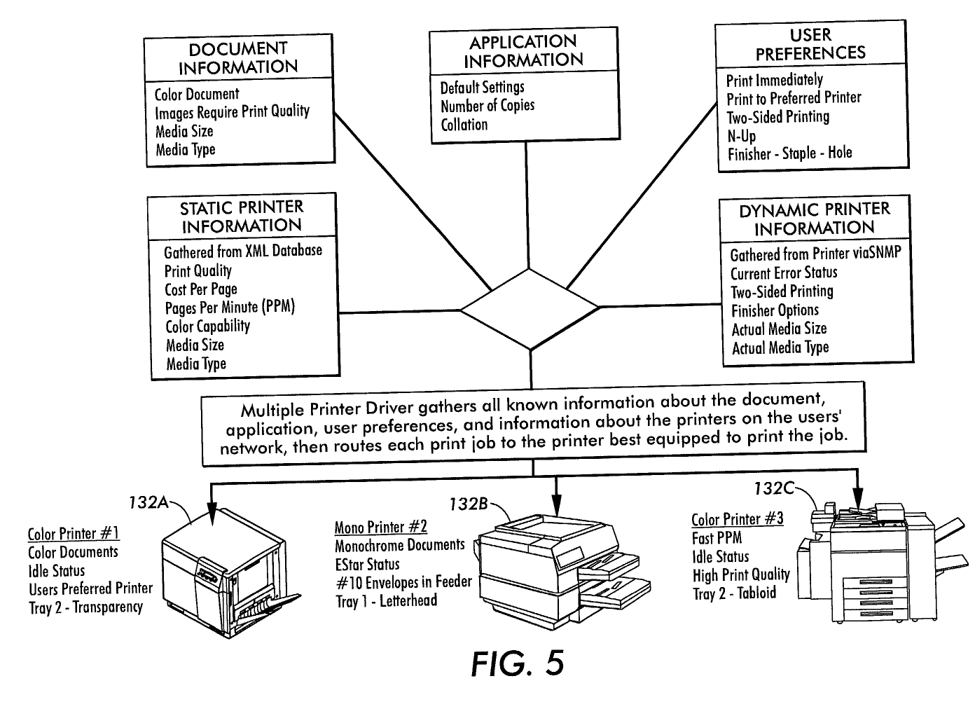

The multiple printer driver gathers all known information about a user's document to be printed, the application calling the print function, user preferences, static and dynamic characteristics of the printers available, analyzes the data and selects the best equipped printer. Referring to FIG. 5, for example, the multiple printer driver gathers document information such as color requirements, images requiring special print quality, media size and media type. The multiple printer driver gathers application information such as default settings, number of copies and collation settings. The multiple printer driver gathers pre-set or print-time user preference settings, including print immediately, print to a preferred printer, two-sided printing, N-Up and finishing preferences (stapled and use holed paper). The multiple printer driver gathers static printer information for each printer, which may be gathered from an XML data base, including print quality, cost per page, pages per minute, color capability, media sizes and media types. The multiple printer driver also gathers dynamic printer information, which may be gathered on the network using SNMP, including current error status (so it does not route the job to a printer which is not up and running), two sided printing capability, finishing options, actual media size and type currently loaded on the printer. For example, printer #1 may be a color printer which is the user's preferred printer, it prints color documents, and tray #2 contains transparencies. If the user submitted a PowerPoint presentation on transparencies, the multiple printer driver would select this printer. Printer #2 is a monochrome printer showing EStar status (economy idle), its feeder contains #10 envelopes and tray #1 contains letterhead. The multiple printer driver would likely select Printer #2 for business letters containing no color. Printer #3 is a color printer with a fast output speed, high print quality and tray #2 contains tabloid paper. The multiple printer driver would likely select this printer to print the department newsletter.

The multiple printer driver selects a compatible printer or offsite-printing solutions (if available on the network) based on the feature set and job requirements selected by the user. If the choice is offsite, the user may be provided with an opportunity to confirm the printer choice made by the multiple printer driver. The document becomes a print job and the print information is bundled and sent to the actual printer driver or offsite solution. The user is provided feedback when the job is finished printing.

The multiple printer driver allows users to print to multiple printers from a single known graphical user interface. The multiple printer driver does not require the user to retain knowledge about the printers and the printer status within their workgroup. The multiple printer driver allows users to focus more on feature rich printing environment rather than being limited to a specific printer's feature set. The multiple printer driver breaches the gap encountered by users between clicking the print button to print a document as opposed to using the driver “properties” tabs to select features. Many users never click the “properties” button from the applications printer setup tab and miss using features available on the printer. By bundling all of the individual printer properties into a composite set of properties in the multiple printer driver user interface, the multiple printer driver provides a direct route to all features in the group of printers and gives many more users access to full-featured printing services.

The multiple printer driver may provide an interface to web based (Off Site) printing solutions. These printing solutions can provide printing services not offered by the onsite printers available to the customers. The multiple printer driver melds color and monochrome printers into a seamless printing solution. The multiple printer driver can save users costs and time by sending print jobs to the most economical or fastest printer available within the workgroup or work site (if those criteria are selected for the controller/logic analyzer).

The multiple printer driver enables different types of printers to be controlled using a single user interface. A standard printer driver, i.e., one that enables a PC to communicate with one printer model and type, includes a translator or format generator for translating a print job into the format required by the printer's print engine. The format required by the printer depends on the type of images to be printed, including fonts. Typical formats include PostScript and PCL and other page description languages. Many printers use the same format. Some printers can process multiple formats. In one embodiment, the multiple printer driver incorporates translators and format generators for each type of printer that it supports.

One embodiment of the multiple printer driver includes a user interface which allows users to select features from a composite list of printer feature sets. The multiple printer driver includes an XML database containing individual printer feature options that allow the multiple printer driver interface to offer the correct choices to the user through a plug-in (a sub-driver) for each particular printer accessed by the multiple printer driver. Each printer plug-in provides the controller/logic analyzer with feature and status information (through the communications port) for that printer type. The controller/logic analyzer selects a printer for a particular print job and feeds the print job specifics to the printer plug-in and the required translator. The multiple printer driver also includes a database of translators for the selected printer formats. A translator database may include a group of PCL translators and a group of Postscript translators. The controller/logic analyzer determines what type of translator is needed for the selected printer, selects the translator and causes the translator to generate the print job in the format required by the selected printer. Then the communications port routes the print job in the desired format to the selected printer.

The multiple printer driver allows users to learn and interact with just a single user interface while printing to many different printers. The multiple printer driver incorporates the static and dynamic capabilities of each different printer within the user's work environment as well as the current status of each printer and routs each document to the best equipped printer to print the document at that time, in accordance with the selection criteria. Users are allowed to identify preferred printers. Most documents may be routed to preferred printers unless the preferred printers are unable to print the job correctly. In this case the multiple printer driver may be configured to automatically route the document to a backup printer.

The multiple printer driver enables users to save printer settings and feature selections on a per-application level. This feature gives users the ability to set up a unique configuration for printing documents from each application installed on the user's PC. The multiple printer driver may be configured to automatically save printer settings and printer feature selections on a per-document level. This feature gives users the freedom to determine what settings to print a document with once and then each subsequent time the users prints that document the Multiple Printer Driver automatically prints the document with the settings the user previously set. The user can of course override the document settings for a document at anytime.

The following exemplary code of a portion of a multiple printer driver according to one embodiment of the invention finds the IP address of the selected printer.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

The invention has been described with reference to particular embodiments for convenience only. Modifications and alterations will occur to others upon reading and understanding this specification taken together with the drawings. The embodiments are but examples, and various alternatives, modifications, variations or improvements may be made by those skilled in the art from this teaching which are intended to be encompassed by the following claims.

What is claimed is:

1. A driver for controlling operation of a plurality printers on a network, wherein each printer includes a plurality of printer features, comprising:
a user interface for displaying a composite of printer features of the plurality of printers in a host device on the network, for receiving a user request for a print job and for receiving user-selected properties from the composite of printer features for the print job;
a controller/logic analyzer, responsive to the request for a print job, the user-selected print job properties and the printer features of the plurality of printers, for selecting, according to predetermined criteria, which printer is to be used for the print job; and
a communications port for routing the print job and selected print job properties to the selected printer.

2. The driver of claim 1, further comprising a query module for querying the plurality of printers for status information and wherein the predetermined criteria include the status information.

3. The driver of claim 1, wherein the predetermined criteria comprise a user-selected printer preference.

4. The driver of claim 1, wherein the printer features comprise media type, media size, media orientation and number of copies.

5. The driver of claim 1, wherein the printer features comprise output features.

6. The driver of claim 1, wherein the printer features comprise color and monochrome.

7. The driver of claim 2, wherein the status information comprises consumable status information.

8. The driver of claim 7, wherein the query module queries each printer for information pertaining to media type, media size, media container status and container name.

9. The driver of claim 1, further comprising an output generator for converting the print job and user-selected print job properties into a printer data format for the selected printer.

10. The driver of claim 9, wherein the printer data format comprises PostScript.

11. The driver of claim 9, wherein the printer data format comprises PCL.

12. The driver of claim 1, wherein the user interface further displays the plurality of printers and wherein the user interface further comprises means for selecting a default printer.

13. The driver of claim 12, wherein the user interface further comprises means for prioritizing the printers.

14. The driver of claim 1, wherein the user interface further displays the plurality of printers; and
further comprising means for adding and removing network printers to be displayed in the user interface.

15. The driver of claim 1, further comprising means for displaying a notice when the print job is complete.

16. The driver of claim 1, further comprising an XML-based database comprising the plurality of printer features.
